(19) United States
(12) Patent Application Publication
(10) Pub. No.: US 2025/0233357 A1
(43) Pub. Date: Jul. 17, 2025

(54) CONNECTOR AND CONNECTOR ASSEMBLY WITH A ROTATING CONNECTOR POSITION ASSURANCE DEVICE

(71) Applicant: Aptiv Technologies AG, Schafhausen (CH)

(72) Inventors: Sylvain LOAS, Le Gault-Saint-Denis (FR); Romain Savina, Saint Martin de Bréthencourt (FR)

(21) Appl. No.: 18/654,392

(22) Filed: May 3, 2024

(30) Foreign Application Priority Data
Jan. 16, 2024 (EP) 24152238.2

(51) Int. Cl. H01R 13/627; H01R 13/629; H01R 13/641

(52) U.S. Cl. CPC H01R 13/6275; H01R 13/62933; H01R 13/641

(57) ABSTRACT

A connector assembly including a connector and a counter-connector mated to each other. The counter-connector includes primary locking means including a rotatable coupling aid lever. The lever is in a closed position when the connector and counter-connector are fully coupled. The connector includes secondary locking means rotatably movable about an axis of rotation, between a locking position and an unlocking position and configured to cooperate, in the locking position, with the primary locking means to lock the lever in the closed position.

### CROSS-REFERENCE TO RELATED APPLICATION

This application claims the benefit of and priority to European Patent Application No. 24152238.2, filed Jan. 16, 2024, the contents of which are incorporated by reference herein.

### TECHNICAL FIELD OF THE INVENTION

The invention relates to the field of connectors, and more particularly to the field of automotive connectors.

### BACKGROUND

Connectors may be equipped with a connector position assurance (CPA) device. Such a CPA device is used to inform an assembly operator about the mating or coupling status of a connector with a counter-connector. For example, the CPA device can be moved from an unlocking position to a locking position only if the connector and the counter-connector are fully, efficiently, and functionally mated. If the connector and the counter-connector are not properly mated, the CPA device is blocked in its unlocking position. An operator is then warned that there is a problem. Further, the CPA device can be used to provide a locking means, or an additional locking means, between the connector and the counter-connector.

In existing connectors, a CPA device mounted on the connector is configured to engage a specific and dedicated feature of the counter-connector when the connector and the counter-connector are properly mated so as to release the CPA device from its unlocking position. Then, the CPA device can be moved toward the locked position where it can provide a locking means or an additional locking means.

There are connector assemblies that have been designed without a CPA device. However, in some cases, it may be worthwhile providing this function.

The aim of this disclosure is to provide this function while keeping manufacturing costs of connector assemblies as low as possible.

### SUMMARY

The present disclosure provides a connector assembly including a connector and a counter-connector mated to each other parallel to a mating direction. The counter-connector includes a primary locking means. The primary locking means includes a coupling aid lever. The lever is rotatable about an axis of rotation perpendicular to the mating direction, between an open position and a closed position. The connector and counter-connector are fully coupled, and the lever is in the closed position. The connector includes a secondary locking means. The secondary locking means are movable between a locking position and an unlocking position. The secondary locking means are configured to cooperate, in the locking position, with the primary locking means to lock the lever in the closed position. The secondary locking means includes a latch rotatable about an axis of rotation parallel to the mating direction. The latch is rotatable between the unlocking position and the locking position.

A rotatable latch does not require a movement of the latch parallel to the mating direction. In the prior art, to unlock the latch of a CPA device, an element is required on the counter-connector to engage the latch. Therefore, adding a CPA function to a connector assembly requires an innovative design of both the connector and the counter-connector.

On the contrary, the connector assembly according to the present disclosure differs from prior art connector assemblies by the fact that it provides a CPA function, without redesigning both the connector and the counter-connector. The connector can be the only component of the connector assembly to be changed for integrating the secondary locking means. Therefore, the mold and the other element of the manufacturing and assembly line for the counter-connector can remain unchanged.

Other advantages are provided by one or several other features listed here-below, considered independently of each other or in combination of one or several others:
the secondary locking means includes an actuating portion with an actuating surface extending radially from the axis of rotation and configured to be manipulated in rotation about the axis of rotation, by an operator, to move the latch from the unlocking position to the locking position, and vice versa;
the secondary locking means includes a locking portion extending parallel to the mating direction, in extension of the actuating portion, the locking portion blocking the lever in the closed position, whereas the connector and the counter-connector are mated;
the secondary locking means includes a reinforcing beam configured to limit a deformation of the locking portion if/when the rotation of the lever is forced from the closed position towards the open position;
the secondary locking means includes an activating lug configured to engage the counter-connector, to unlock the latch from its unlocking position, when the connector is mated to the counter-connector;
the connector includes a housing and the secondary locking means includes a locking means configured to cooperate with an abutment surface fixed relative to the housing, the cooperation of the locking means with the abutment surface blocking the latch in the unlocking position;
the secondary locking means includes an activating means located on flexible means, the activating means being configured to cooperate with the counter-connector and being configured to deflect the flexible means to release the locking means from the abutment surface, when the connector and the counter-connector are mated;
the flexible means and the locking means are at least partially covered by a guiding and protecting wall;
the connector includes an indexing means to visually indicate whether the secondary locking means are in the unlocking position or the locking position.

The disclosure also relates to a connector, for example, that of the above-mentioned connector assembly. This connector then has a housing with at least one cavity for accommodating a terminal, said terminal having a contact portion extending in a mating direction. This connector also has secondary locking rotatably mounted on the housing between a locking position and an unlocking position. The secondary locking means includes a latch rotatable about an axis of rotation parallel to the mating direction, between the unlocking position and the locking position.

### BRIEF DESCRIPTION OF THE DRAWINGS

The present invention is now described, by way of example with reference to the accompanying drawings, in which:

FIG. 1 is an isometric view of a counter-connector according to some embodiments.

FIG. 2 is an isometric view of a connector configured to be mated with the counter-connector of FIG. 1 according to some embodiments.

FIG. 3 is an alternative isometric view of the connector of FIG. 2 according to some embodiments.

FIG. 4 is an isometric view of a latch configured to be mounted on the connector of FIGS. 2 and 3 according to some embodiments.

FIG. 5 is an alternative isometric view of the latch of FIG. 4 according to some embodiments.

FIG. 6 is an isometric view of a portion of the connector of FIGS. 2 and 3, on which the latch of FIGS. 4 and 5 is mounted, the latch being in its unlocking position according to some embodiments.

FIG. 7 is an alternative isometric view of FIG. 6, with a portion of the guiding and protecting wall partially removed according to some embodiments.

FIG. 8 is a transverse cross-section view of a connector assembly including connector of FIGS. 2 and 3 and the counter-connector of FIG. 1, the latch being in its unlocking position according to some embodiments.

FIG. 9 is a transverse cross-section view of a connector assembly with the latch being in its locking position according to some embodiments.

FIG. 10 is a longitudinal cross-section view of the connector assembly, the latch being in its unlocking position according to some embodiments.

FIG. 11 is a longitudinal cross-section view of the connector assembly with the latch being in its locking position according to some embodiments.

FIG. 12 is an alternate longitudinal cross-section view of the connector assembly with the latch being in its locking position according to some embodiments.

### DETAILED DESCRIPTION

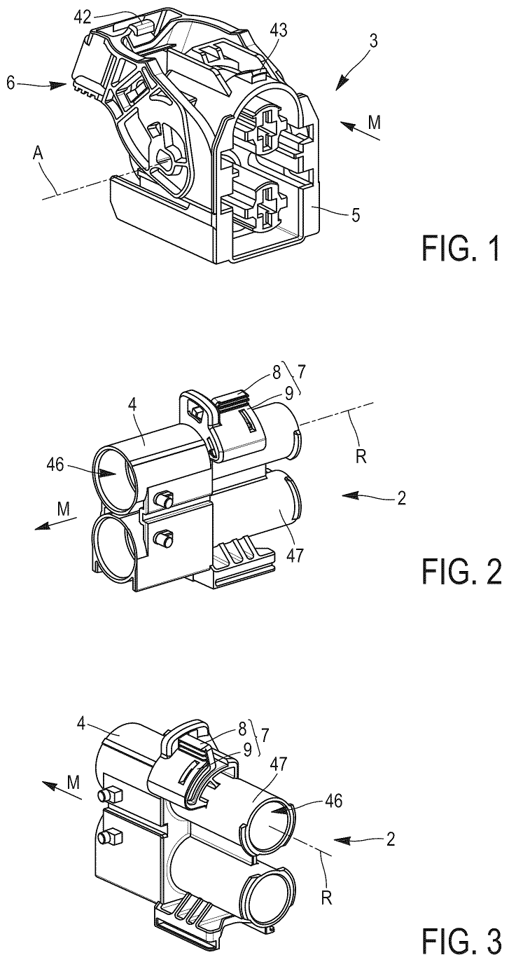

A connector assembly 1 is described below. This connector assembly 1 includes a connector 2 (see FIGS. 2 and 3, for example) and a counter-connector 3 (see FIG. 1, for example). For example, the connector 2 is a male connector and the counter-connector 3 is a female connector. For example, the connector 2 and counter-connector 3 are two-way connectors. However, this disclosure can be transposed to one-way connectors or connectors including more than two ways. Thus, according to this example, the connector 2 includes a housing 4 in which two electrically conductive male terminals (not shown in the figures) are housed and the counter-connector 3 includes a housing 5 in which two electrically conductive female terminals (not shown in the figures) are housed. According to the example of an embodiment shown in the figures, the male terminals of the connector 2 are housed in cylindrical cavities 46. More particularly, each cavity 46 has an outer wall 47 (see FIG. 3) which is substantially cylindrical.

The housings 4 and 5 are made by moulding an insulating plastic material.

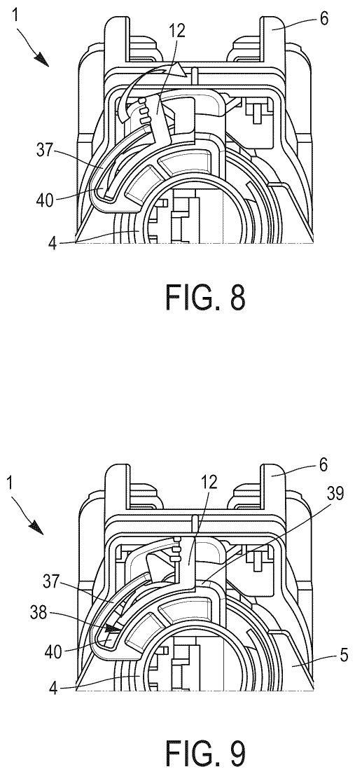

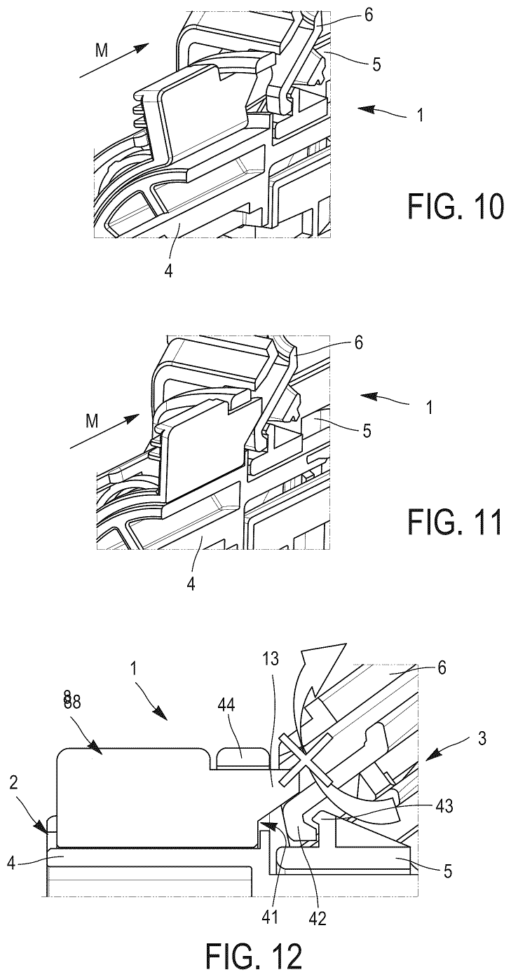

The connector 2 and the counter-connector 3 are configured to be mated with each other, along a mating direction M, so that their respective terminals establish an electrical connection. In other words, the male and female terminals respectively have a contact portion essentially extending parallel to the mating direction M. To ease and secure the coupling of the connector 2 and the counter-connector 3, the counter-connector 3 is equipped with a coupling aid lever 6 (also called mate assist lever). The lever 6 is rotatably mounted, on the housing 5 of the counter-connector 3, about an axis of rotation A perpendicular to the mating direction M. The lever 6 is configured to rotate about the axis of rotation A, between an open position (see FIG. 1) in which the connector 2 and the counter-connector 3 are not mated, and a closed position in which the connector 2 and the counter-connector 3 are fully mated (FIGS. 8 to 12).

The counter-connector 3 may be originally designed to be mounted on a header (not shown) which does not necessarily include a connector position assurance (CPA) device. However, in the context of the present disclosure, it is desired that the connector 2 includes such a CPA device to ensure that the connector 2 and the counter-connector 3 are actually positioned relative to each other, in a position corresponding to a complete coupling and that this position is maintained locked when the connector assembly 1 is to be functional.

Thus, without changing the existing design of the counter-connector 3, the connector 2 is designed with a CPA device 7 that provides the above functions (ensuring full mating of the connector 2 and counter-connector 3 and locking the connector 2 and counter-connector 3 in the fully mated position).

The CPA device 7 includes a latch 8 and a holder 9 for the latch 8. The latch 8 is movably mounted in the holder 9. For example, the holder 9 is integral with the housing 4 of the connector 2. The latch 8 is rotatable about an axis of rotation R essentially parallel to the mating direction M between an unlocking position (FIGS. 2, 3, 6, 7, 8 and 10) and a locking position (FIGS. 9, 11 and 12).

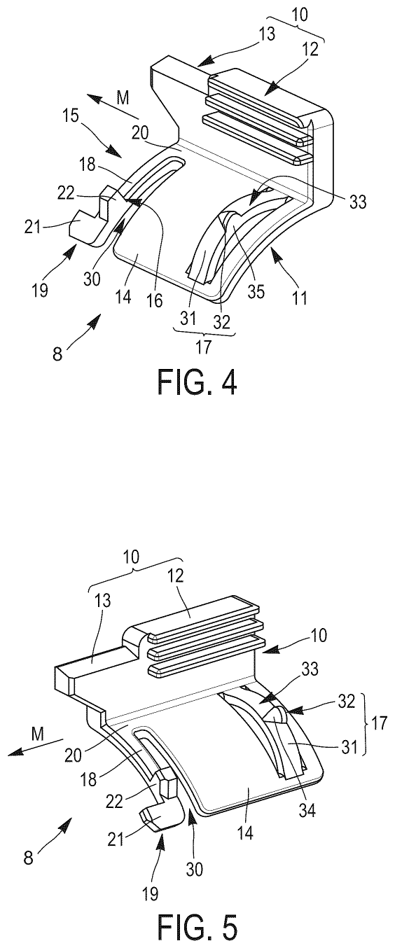

The latch 8 has a latch portion 10 and a guide portion 11 (see FIG. 4). The latch portion 10 itself has an actuating portion 12 and a locking portion 13.

The guide portion 11 and the holder 9 have a curved shape about the axis of rotation R which essentially follows the curvature of one of the outer walls 47 of the cavities 46.

The actuating portion 12 is configured to be manipulated and/or pressed by an operator to move the latch 8 from the unlocking position to the locking position, and vice versa. The actuating portion 12 extends radially outwardly from the connector 2, from the guide portion 11. The actuating portion 12 is very ergonomic. Its operation is very intuitive. The locking portion 13 extends substantially, from the actuating portion 12, in the mating direction M. In other words, the locking portion 13 extends parallel to the mating direction M, in extension of the actuating portion 12. Therefore, the latch portion 10 is quite simple, compact, robust, and easy to mold. The locking portion 13, as described below, is configured to interfere with the lever 6 when the latter is in the closed position.

The guide portion 11 is essentially in the form of a curved plate 14 (like a tile) which is curved around the rotation axis R of the latch 8. The guide portion 11 includes a CPA activating means 15 (i.e. means for activating the CPA device 7), a locking means 16 (i.e. means for locking the latch 8 in the unlocking position), and a guiding and retaining means 17 (i.e. means for guiding and retaining the latch 8 in the holder 9).

More particularly, according to an embodiment example, the guide portion 11 includes a flexible tab 18. This flexible tab 18 extends essentially over a curved portion, essentially, with the same radius of curvature as the curved plate 14, between a free end 19 remote from the actuating portion 12 and a joining zone 20 closer to the actuating portion 12.

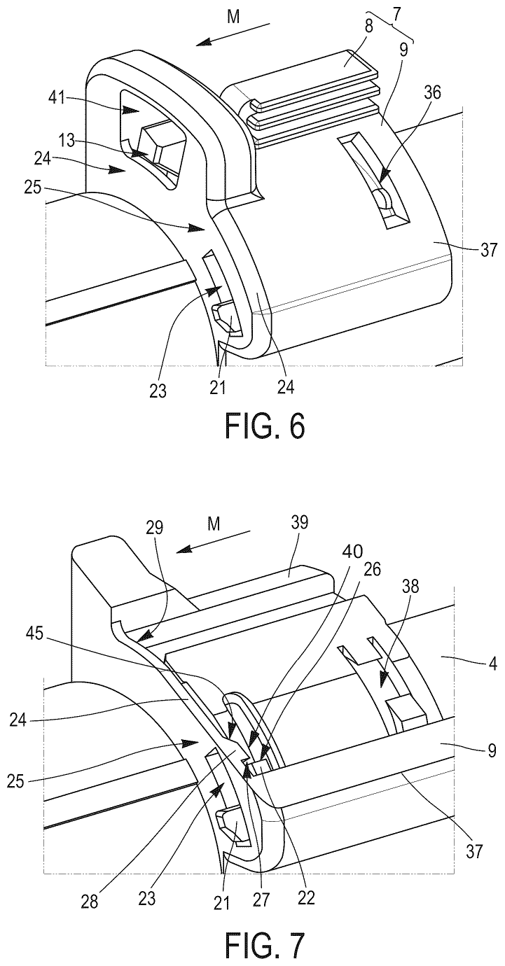

More particularly also, according to an embodiment example, the free end 19 is provided with an activating lug 21 and a locking lug 22. The activation means 15 of the CPA device thus includes the activating lug 21 and the flexible tab 18. The locking means 16 of the latch 8 in the unlocking position therefore includes the locking lug 22 and the flexible tab 18. The activating lug 21 extends from the free end 19, in the mating direction M, passes through a slot 23 provided in an abutment wall 24 of the holder 9 (this abutment wall 24 extending substantially perpendicularly to the mating direction M), and protrudes (in the mating direction M) from an outer face 25 of this abutment wall 24 (see FIG. 6). A clearance space 30 is provided between the flexible tab 18 and the remainder of the curved plate 14. Thus, when a force is exerted on the activating lug 21 in a direction opposite to the mating direction M, the flexible tab 18 (and more particularly its free end 19) can move back into the clearance space 30.

The locking lug 22 extends from the free end 19, substantially in a radial direction with respect to the axis of rotation R, into the interior of a cavity 40 formed in the holder 9 (see FIG. 7). The locking lug 22 has an abutment surface 26 configured to cooperate with a counter abutment surface 27 formed on a protrusion 28 projecting (in the opposite direction to the mating direction M) from an inner face 29 of the abutment wall 24 (see FIG. 7). The locking lug 22 and the protrusion 28 maintain the latch 9 in the unlocking position when the abutment surface 26 is locked behind the counter abutment surface 27.

More particularly also, according to an embodiment example, the guiding and the retaining means 17 include a bridge 31 (see FIG. 5). This bridge 31 extends in an arc above the curved plate 14, with a radius of curvature smaller than that of the curved plate 14. The bridge 31 has a projection 32. This projection 32 extends in a radial direction with respect to the axis of rotation R, from an upper surface 33 of the bridge 31. The projection 32 has a bevelled surface 34 (see FIG. 5) and an abutment surface 35 (see FIG. 4). The abutment surface 35 is oriented substantially in a direction opposite to the mating direction M. The projection 32 is configured to enter a slot 36 in a guiding and protecting wall 37 of the holder 9 (see FIG. 6). The projection 32 and this slot 36 are configured to allow the movement of the projection 32 into the slot 36, when the latch 8 is moved from its locking position to its unlocking position, and vice versa. The position in the slot 36 of the projection 32 (which is visible through the slot 36) provides an index about the position (locking or unlocking position) of the CPA device 7 and its latch 8.

According to the embodiment example described here, the holder 9 includes the abutment wall 24, the guiding and protecting wall 37, a sliding surface 38 and a blocking wall 39 (see FIG. 7). Together these elements define the cavity 40 in which a major part of the guide portion 11 of the latch 8 is accommodated (see FIG. 8). As mentioned above, the abutment wall 24 extends substantially perpendicular to the mating direction M. It includes the slot 23, as well as an opening 41 configured to allow the locking portion 13 to pass through the abutment wall 24 (see FIG. 6). The sliding surface 38 may be formed on an outer face of the housing 4 of the connector 2. The sliding surface 38 and the curved plate 14 are configured to slide on each other when the latch 8 is moved from its locking position to its unlocking position, and vice versa. The guiding and protecting wall 37 is configured to cover a major part of the curved plate 14. More particularly, the flexible tab 18 and the locking lug 22 are covered by the guiding and protecting wall 37. In a cross-section perpendicular to the mating direction M (see FIGS. 8 and 9), the sliding surface 38 and the guiding and protecting wall 37 extend over curves which are substantially parallel to each other on either side of the cavity 40. The radial distance between the sliding surface 38 and the guiding and protecting wall 37 is greater than the height of the locking lug 22 (this height being considered to also include the thickness of the curved plate 14). Thus, the locking lug 22 does not hinder the movement of the latch 8 from its locking position to its unlocking position, and vice versa (except when it cooperates, in the unlocking position, with the protrusion 28). On the other hand, the radial distance between the sliding surface 38 and the guiding and protecting wall 37 is smaller than the height of the bridge 31 and the projection 32. However, thanks to the slot 36, the bridge 31 and the projection 32 do not hinder the movement of the latch 8 from its locking position to its unlocking position, and vice versa.

According to the example embodiment described here, the blocking wall 39 is configured to cooperate with the actuating portion 12, when the latch 8 is in the locking position (see FIG. 9).

To mount the latch 8 in the holder 9, the latch 8 is inserted into the cavity 40 essentially parallel to the mating direction M, with the front portion of the latch 8 (i.e. the portion carrying the flexible tab 18) being presented into the cavity 40 first. As mentioned above, the height of the activating lug 21 allows the insertion of this front portion (i.e. the flexible tab 18) between the sliding surface 38 and the guiding and protecting wall 37. As the latch 8 is further inserted into the cavity 40, the curved plate 14 is further inserted between the sliding surface 38 and the guiding and protecting wall 37, until the bridge 31 and the projection 32 are retained at the entrance to the cavity 40. However, the bridge 31 is sufficiently flexible so that the friction of the bevelled surface 34 on the guiding and protecting wall 37 causes it to bend, which allows it to retract under the guiding and protecting wall 37, when a sufficient force is exerted onto the latch 8, in the mating direction M. When the bridge 31 reaches the slot 36, it can resume its original shape (without mechanical stress and without deformation). The abutment surface 35 then cooperates with an edge of the slot 36 to prevent the latch 8 from being removed from the holder 9 (e.g. if pulled in a direction opposite to the mating direction M).

The connector 2 is delivered with the latch 8 in the unlocking position. The latch 8 is held in this unlocking position by the co-operation of the abutment surface 26 of the locking lug 22, with the counter abutment surface 27 of the protrusion 28. When the latch 8 is in this unlocking position, an operator can see that the latch portion 10 is properly positioned so as not to interfere with the closing of the lever 6. As already mentioned, the position of the projection 32 in the slot 36 provides an index that can also be used to check that the latch 8 is in the unlocking position. The position of the activating lug 21 in the slot 23 may also allow this verification.

In order to couple the connector 2 with the counter-connector 3, these are presented with their coupling face facing each other. A relative movement of the connector 2 and the counter-connector 3 parallel to the mating direction M is then conducted until the housing 5 of the counter-connector 3 comes to rest on the abutment wall 24. This movement is assisted by the lever 6 which then moves from its open position (allowing the coupling of the connector 2 with the counter-connector 3) to its closed position, in which the connector 2 and the counter-connector 3 are completely and correctly coupled and mated. According to an embodiment example of the counter-connector 3, it includes a lever 6 with a hook 42 and a housing 5 with a latch 43 (see FIGS. 11 and 12). When the lever 6 is rotated to its locking position, the hook 42, which has a certain flexibility, is deformed to hook onto the latch 43. Thus, the hook 42 (or more particularly. the lever 6 with hook 42) and the latch 43 form the primary locking means of the lever 6 and, consequently, of the connector assembly 1.

In the closed position of the lever 6, the housing 5 of the counter-connector 3 presses the activating lug 21 in a direction opposite to the mating direction M, causing the flexible tab 18 to move back into the clearance space 30. One can note that there is no need to change the design of the counter-connector 3 and/or to add a feature to it. It is enough to have the activating lug 21 configured to engage a portion and/or a surface of the counter-connector 3, to unlock the latch 8 from its unlocking position, when the connector 2 is fully mated to the counter-connector 3. The locking lug 22 escapes the protrusion 28. This releases the latch 8 from its unlocking position. The latch 8 can then be moved to its locking position, in which the actuating portion 12 cooperates with the blocking wall 39, to prevent movement of the latch 8 beyond this locking position. When the latch 8 is in the locking position, the locking portion 13 co-operates with the lever 6 to retain the lever 6 in the closed position. In particular, the locking portion 13 is disposed above the hook 42 to prevent the hook 42 from deforming and releasing from the latch 43. The latch 8 thus provides a secondary locking means of the lever 6 (See FIG. 12).

In addition, the abutment wall 24 has a reinforcing beam 44 above the opening 41 which prevents the locking portion 13 from moving upwards (upwards in FIG. 12) if the lever 6 is pulled from its closed to its open position.

A ramp 45 (see FIG. 7) cooperates with the locking lug 22 to hold the latch 8 in the locking position (elastically due to the restoring force exerted by the flexible tab 18).

The position of the projection 32 in the slot 36 also makes it possible to check that the latch 8 is in the locking position. The position of the activating lug 21 (if still visible) in the slot 23 may also allow this verification.

Conversely, to uncouple the connector 2 and the counter-connector 3, the latch 8 is moved from its locking position to its unlocking position. The lever 6 is then released. An operator can move it from its closed position to its open position, thus causing a relative displacement of the connector 2 and the counter-connector 3 corresponding to their unmating.

One can note that thank to its rotatable configuration, the CPA device 7 provides several advantages such as:
its ease of handling thanks to its large gripping surfaces over the actuating portion 12;
its simplicity of use because of its rotary movement which is very intuitive;
the fact that it can be used with connectors for which the dimension parallel to the mating direction M must remain relatively short; indeed, CPA devices actuated, between the locking and unlocking positions, along a stroke parallel to the mating direction M require a stroke that is not required by CPA devices rotatably actuated about an axis parallel to this mating direction M;
there is no need to change the design of the counter-connector 3 to provide the connector assembly with the secondary locking means.

### Discussion of Possible Embodiments

The following are non-exclusive descriptions of possible embodiments of the present invention.

In some aspects, the techniques described herein relate to a connector assembly, including: a connector; and a counter-connector mated to each other parallel to a mating direction, wherein the counter-connector includes primary locking means including a coupling aid lever which is rotatable about an axis of rotation perpendicular to the mating direction between an open position and a closed position, wherein the lever is in the closed position when the connector and counter-connector are fully coupled, wherein the connector includes secondary locking means movable between a locking position and an unlocking position and configured to cooperate, while in the locking position, with the primary locking means to lock the lever in the closed position, and wherein the secondary locking means includes a latch rotatable about an axis of rotation parallel to the mating direction, between the unlocking position and the locking position.

The connector assembly of the preceding paragraph can optionally include, additionally and/or alternatively any, one or more of the following features, configurations and/or additional components.

In some aspects, the techniques described herein relate to a connector assembly, wherein the secondary locking means includes an actuating portion with an actuating surface extending radially from the axis of rotation and configured to be rotationally manipulated about the axis of rotation by an operator to move the latch from the unlocking position to the locking position, and vice versa.

In some aspects, the techniques described herein relate to a connector assembly, wherein the secondary locking means includes a locking portion extending parallel to the mating direction, in extension of the actuating portion, wherein the locking portion blocks the lever in the closed position when the connector and the counter-connector are mated.

In some aspects, the techniques described herein relate to a connector assembly, wherein the secondary locking means includes a reinforcing beam configured to limit a deformation of the locking portion if the rotation of the lever is forced from the closed position towards the open position.

In some aspects, the techniques described herein relate to a connector assembly, wherein the secondary locking means includes an activating lug configured to engage the counter-connector to unlock the latch from its unlocking position when the connector is mated to the counter-connector.

In some aspects, the techniques described herein relate to a connector assembly, wherein the connector includes a housing and the secondary locking means includes locking means configured to cooperate with an abutment surface fixed relative to the housing, wherein cooperation of the locking means with the abutment surface blocks the latch in the unlocking position.

In some aspects, the techniques described herein relate to a connector assembly, wherein the secondary locking means includes activating means located on a flexible means, wherein the activating means is configured to cooperate with the counter-connector and to deflect the flexible means to release the locking means from the abutment surface when the connector and the counter-connector are mated.

In some aspects, the techniques described herein relate to a connector assembly, wherein the flexible means and the locking means are at least partially covered by a guiding and protecting wall.

In some aspects, the techniques described herein relate to a connector assembly, including indexing means to visually indicate whether the secondary locking means are in the unlocking position or the locking position.

In some aspects, the techniques described herein relate to a connector, including: a housing defining at least one cavity; a terminal accommodated in the at least one cavity, the terminal having a contact portion extending in a mating direction; and a secondary locking means rotatably mounted on the housing and rotatable between a locking position and an unlocking position, wherein a secondary locking means includes a latch rotatable about an axis of rotation parallel to the mating direction between the unlocking position and the locking position.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector assembly, comprising:
a connector; and
a counter-connector mated to each other parallel to a mating direction, wherein the counter-connector comprises primary locking means comprising a coupling aid lever which is rotatable about an axis of rotation perpendicular to the mating direction between an open position and a closed position, wherein the lever is in the closed position when the connector and counter-connector are fully coupled, wherein the connector comprises secondary locking means movable between a locking position and an unlocking position and configured to cooperate, while in the locking position, with the primary locking means to lock the lever in the closed position, and wherein the secondary locking means comprises a latch rotatable about an axis of rotation parallel to the mating direction, between the unlocking position and the locking position.

2. The connector assembly according to claim 1, wherein the secondary locking means comprises an actuating portion with an actuating surface extending radially from the axis of rotation and configured to be rotationally manipulated about the axis of rotation by an operator to move the latch from the unlocking position to the locking position, and vice versa.

3. The connector assembly according to claim 2, wherein the secondary locking means comprises a locking portion extending parallel to the mating direction, in extension of the actuating portion, wherein the locking portion blocks the lever in the closed position when the connector and the counter-connector are mated.

4. The connector assembly according to claim 3, wherein the secondary locking means comprises a reinforcing beam configured to limit a deformation of the locking portion if the rotation of the lever is forced from the closed position towards the open position.

5. The connector assembly according to claim 1, wherein the secondary locking means comprises an activating lug configured to engage the counter-connector to unlock the latch from its unlocking position when the connector is mated to the counter-connector.

6. The connector assembly according to claim 1, wherein the connector comprises a housing and the secondary locking means comprises locking means configured to cooperate with an abutment surface fixed relative to the housing, wherein cooperation of the locking means with the abutment surface blocks the latch in the unlocking position.

7. The connector assembly according to claim 6, wherein the secondary locking means comprises activating means located on a flexible means, wherein the activating means is configured to cooperate with the counter-connector and to deflect the flexible means to release the locking means from the abutment surface when the connector and the counter-connector are mated.

8. The connector assembly according to claim 7, wherein the flexible means and the locking means are at least partially covered by a guiding and protecting wall.

9. The connector assembly according to claim 1, comprising indexing means to visually indicate whether the secondary locking means are in the unlocking position or the locking position.

10. A connector, comprising:
a housing defining at least one cavity;
a terminal accommodated in the at least one cavity, the terminal having a contact portion extending in a mating direction; and
a secondary locking means rotatably mounted on the housing and rotatable between a locking position and an unlocking position, wherein a secondary locking means comprises a latch rotatable about an axis of rotation parallel to the mating direction between the unlocking position and the locking position.
